(19) United States
(12) Patent Application Publication
(10) Pub. No.: US 2012/0054355 A1
(43) Pub. Date: Mar. 1, 2012

(54) METHOD AND APPARATUS FOR GENERATING A VIRTUAL INTERACTIVE WORKSPACE WITH ACCESS BASED ON SPATIAL RELATIONSHIPS

(75) Inventors: Juha Arrasvuori, Tampere (FI); Andrés Lucero, Tampere (FI); Jaakko Keränen, Tampere (FI); Hannu Korhonen, Kangasala (FI); Tero Jokela, Tampere (FI); Marion Boberg, Suinula (FI); Jussi Holopainen, Tampere (FI)

(73) Assignee: Nokia Corporation

(21) Appl. No.: 12/872,680

(22) Filed: Aug. 31, 2010

(51) Int. Cl. G06F 15/16

(52) U.S. Cl. 709/229

(57) ABSTRACT

A method for providing access management for a virtual workspace may include receiving location information defining a distance between a first device and at least one other device forming a virtual workspace in association with the first device, determining an access status of the virtual workspace based on the location information, and causing enabling or disabling of access to the virtual workspace based on the access status determined. A corresponding apparatus is also provided.

### TECHNOLOGICAL FIELD

Some example embodiments of the present invention relate generally to user interface technology and, more particularly, relate to a method and apparatus for providing a virtual interactive workspace and corresponding user interface that provides access based on spatial relationships between devices in the virtual interactive workspace.

### BACKGROUND

Mobile devices are rapidly becoming the computing device of choice for today's tech-savvy, on-the-go users. Very often, mobile device users desire to engage in real-time collaborative processing tasks or social networking sessions with other wireless device users. The rise in popularity of social networking mediums such as Facebook®, MySpace®, Linkedln®, Twitter®, various blogs sites, chat rooms, peer-to-peer applications and the like, is due in large part to the fact that such interaction can be performed on-the-go.

Of course, the overall quality of experience of a mobile device user as the user engages with others in a collaborative networking environment depends on various factors. In particular, the experience depends on the extent to which the user's device can visually depict all involved parties. Another important factor is the ability of shared services or applications to promote seamless interaction amongst users (e.g., real-time file sharing). As yet another factor, the persistent movement, orientation, placement or whereabouts of users relative to a defined physical or network environment in which they interact is also an important aspect of the quality of the experience. Unfortunately, while today's social networking and collaborative software applications are designed to readily facilitate user interaction, the small display of today's wireless devices limits the extent of this interactivity. The small form factor of mobile devices, while making them attractive for mobility purposes, nonetheless allows for only a limited amount of information to be presented at a time. This can significantly diminish the collaborative visual and interactive perspective the user desires.

### BRIEF SUMMARY

A method, apparatus and computer program product are therefore provided for enabling provision of a virtual interactive workspace and corresponding user interface that provides access to content based on spatial relationships between devices in the virtual interactive workspace. In particular, a method, apparatus and computer program product are provided that may enable the user to have selective control over the opening or closing of the virtual interactive workspace based on the distance between devices. Thus, for example, the distance between devices may be used as a determining factor as to whether the virtual interactive workspace is open or closed and therefore whether access to content is permitted or not.

In one example embodiment, a method of providing access management for a virtual workspace is provided. The method may include receiving location information defining a distance between a first device and at least one other device forming a virtual workspace in association with the first device, determining an access status of the virtual workspace based on the location information, and causing enabling or disabling of access to the virtual workspace based on the access status determined.

In another example embodiment, a computer program product for providing access management for a virtual workspace is provided. The computer program product may include at least one computer-readable storage medium having computer-executable program code instructions stored therein. The computer-executable program code instructions may include program code instructions to receive location information defining a distance between a first device and at least one other device forming a virtual workspace in association with the first device, determine an access status of the virtual workspace based on the location information, and cause enabling or disabling of access to the virtual workspace based on the access status determined.

In another example embodiment, an apparatus for providing access management for a virtual workspace is provided. The apparatus may include at least one processor and at least one memory including computer program code. The at least one memory and the computer program code may be configured to, with the at least one processor, cause the apparatus at least to receive location information defining a distance between a first device and at least one other device forming a virtual workspace in association with the first device, determine an access status of the virtual workspace based on the location information, and cause enabling or disabling of access to the virtual workspace based on the access status determined.

In another example embodiment, an apparatus for providing access management for a virtual workspace is provided. The apparatus may include means for receiving location information defining a distance between a first device and at least one other device forming a virtual workspace in association with the first device, means for determining an access status of the virtual workspace based on the location information, and means for causing enabling or disabling of access to the virtual workspace based on the access status determined.

Some embodiments of the invention may provide a method, apparatus and computer program product for improving user interaction with content that is introduced into a virtual workspace. As a result, for example, mobile terminal users may enjoy improved capabilities with respect to content sharing and other social and spatial interactions in a virtual workspace environment.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a diagram of a system capable of enabling equipment users to interact with one another within the context of a collaborative, virtual networking environment, according to an example embodiment;

FIG. 2A is a flowchart depicting the process for enabling equipment users to interact with one another within the context of a collaborative, virtual networking environment, according to an example embodiment;

FIGS. 2B-2D are diagrams of several user equipment interacting to generate and collaborate within a virtual workspace environment as described with respect to FIG. 2A, according to various example embodiments;

FIG. 3, which includes FIGS. 3A to 3E, illustrates an example in which a virtual workspace is defined between two devices with access to the virtual workspace being provided based on the distance between the two devices according to an example embodiment;

FIG. 4, which includes FIGS. 4A and 4B, illustrates configurations of example embodiments with four devices;

FIG. 5 illustrates a configuration in which three devices are used to define an open virtual workspace according to an example embodiment;

FIG. 6 illustrates an example in which a three dimensional virtual workspace is defined between two devices according to an example embodiment;

FIG. 7 is a diagram of an apparatus for providing access management for a virtual workspace according to an example embodiment of the present invention; and

FIG. 8 is a block diagram according to an example method for providing access management for a virtual workspace according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Examples of a method, apparatus, and computer program for enabling the convenient generation of a virtual workspace for sharing and processing data and communicating amongst a plurality of user equipment—e.g., mobile devices—are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

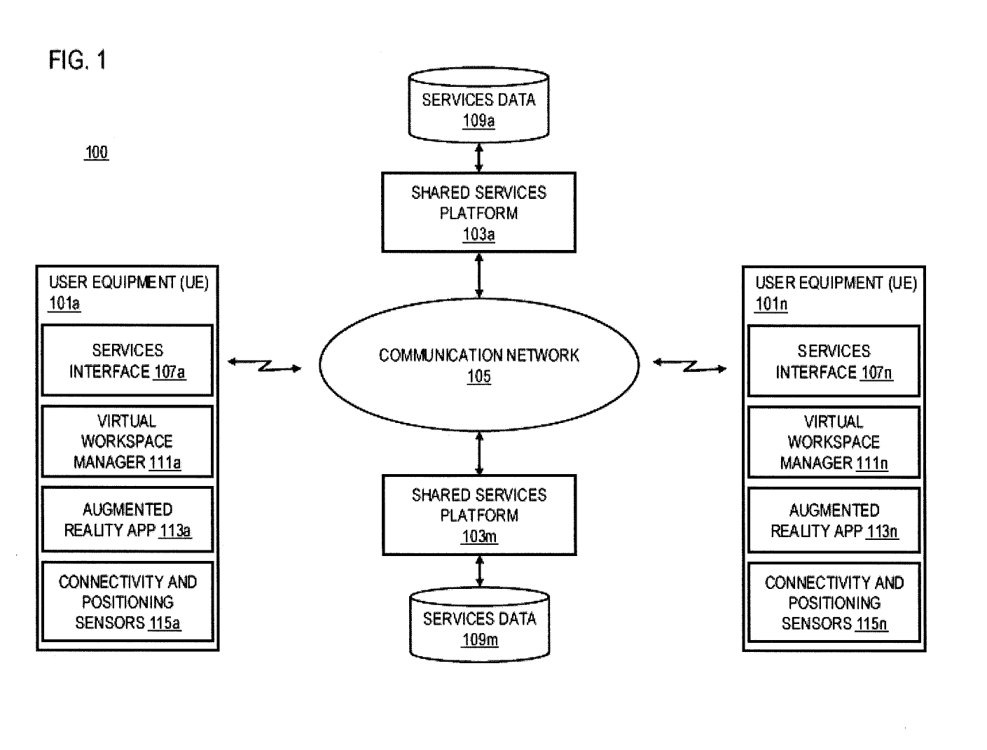

FIG. 1 is a diagram of a system capable of enabling mobile equipment users to interact with one another within the context of a collaborative, virtual networking environment, according to one embodiment. As mentioned before, popular social networking applications and services allow users to readily share content including media such as images, music and video, communicate over one or more social networking platforms, perform various file or data processing tasks, control other devices through various signal processing and control means, etc. Unfortunately, mobile devices by default feature relatively small visual displays, which can only show a limited amount of information. With such limited visual perspective, the user may be limited in terms of the level of social or physical interactivity they enjoy with respect to the various users with which they are engaged. Even when the user's mobile equipment is a conventional computing device such as a netbook, notebook or laptop featuring a larger display than that of a cell phone or Smartphone, confining a shared workspace to the dimensions of an operating system desktop may reduce the quality of the collaborative experience.

Hence, an example approach is described herein that pertains to methods and systems for enhancing the ability of user equipment to perform shared processing and communication tasks using the space outside the device screen as a virtual workspace. As used herein, the term “workspace” refers to the proximal amount of physical or virtually perceivable space made available to a device user for interacting with other users for the purpose of performing various shared processing or communication tasks (work). With this in mind, a “virtual workspace” as presented herein pertains to any perceivable space that can be rendered to a user device in a manner suitable for representing a broader physical, social or network environment or shared processing context. Within the workspace, a user can interact with other users through active participation and sharing of common services within the same environment. System 100 of FIG. 1 presents an implementation of such a workspace in accord with one embodiment.

The system 100 comprises different user equipment (UEs) 101a-101n (also collectively referred to as UEs 101) having connectivity to one or more shared services platforms 103a-103m (also collectively referred to as shared services platform 103) via a communication network 105. In one embodiment, each of the UEs 101 includes respective services interfaces 107a-107n (also collectively referred to as services interfaces 107). As an example, the services interface 107 allows the respective UE 101 to exchange or share data over the network 105 with the shared services platform 103 and/or other UEs 101. The data can be any content, information or applications intended to be stored to and retrieved from the shared services platform 103 as services data 109a-109m (also collectively referred to as services data 109). This can include, but is not limited to, images, video, audio, contact list data, executable instruction sets such as applets, documents, message threads, profile data, visual descriptors, etc. By way of example, the services interface 107 may be a dedicated media management application (e.g., a web service application), an internet browser from whence the user may establish a session with the media services platform 103, or the like.

In general, the services interface 107 and the media services platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), personal area network (PAN) (e.g., a Bluetooth® PAN), and the like.

The shared services platform 103 pertains to any hosted (or even client/server based) applications intended to promote the exchange of data, enable concurrent processing capability between users or facilitate interactive or real-time communication between one or more registered users of said service. Examples include, but are not limited to social networking service providers such as Facebook®, MySpace® and LinkedIn®, shared content and application processing providers such as Google Apps® by Google®, Exchange® or Office Live® by Microsoft® and Huddle® applications, various cloud computing or shareware/groupware providers, or the like. In general, the shared services platforms provide differing capabilities to users who collaborate with one another using it, including but not limited to contact and profile management—i.e., for the user and his/her social or business network contacts), discussion/chat rooms, whiteboards, file sharing, document creation and management, project management, permissions and restrictions management, meeting and conference management, content/user/data search capability, shared dashboard capability, etc. As capabilities and providers differ vastly, many of the aforementioned capabilities are generally integrated in the shared services platform 103. Hence, any platform for facilitating collaboration between users is within the scope of the inventive concepts presented herein. Data produced or exchanged by participants is maintained by the respective shared services platform 103 as services data 109.

As mentioned above, there are many different shared services platform providers and applications. It should be noted that the different UEs 101 may access different shared services platforms 103 depending on the preferences of a respective user. Hence, in the figure as shown, distinct users of UEs 101 can access the same shared services platform 103a or a different platform 103m for the purposes of facilitating communication amongst themselves or other users. It will be seen in later discussions that regardless of the platform of choice, the approach described herein enables convenient sharing of services data 111 amongst users independent of the chosen platform 103.

In addition to the services interface 107, each of the UEs 101 features respective virtual workspace managers 111a-111n (also collectively known as virtual workspace managers 111) and augmented reality applications 113a-113n (also collectively known as augmented reality applications 113). In one embodiment, the virtual workspace manager 111 includes one or more components (not shown) for generating a virtual workspace among a plurality of UEs 101 based, at least in part, on the location information of the UEs 101, and then manipulating the virtual workspace based on the movement or locations of the corresponding ones of the UEs 101. By way of example, the virtual workspace may be used to depict a user interface of one or more applications, services, or the like that are common to the UEs 101. It is contemplated that the functions of the virtual workspace manager 111 may be combined in one or more components or performed by other components of equivalent functionality (e.g., the shared services platform 103).

In certain embodiments, once the virtual workspace is created by the virtual workspace manager 111, the UE 101 enables the augmented reality applications 113 to generate real-time representations of the virtual workspace environments with virtual computer-generated imagery. More specifically, the view of workspace is modified or generated by the application 113 and/or the virtual workspace manager 111 such that the view of the virtual workspace presented in any one of the participating UEs 101 is based, at least in part, on an orientation (e.g., location, directional heading, tilt angle, etc.) of the UE 101 in relation to the virtual workspace. For example, when the UE 101 is operating in an orientation that is within the same plane as the virtual workspace, the augmented reality application 113 and/or the virtual workspace manager 111 may depict, for instance, a virtual window showing a portion of the virtual workspace that is visible from the perspective of the UE 101. When the UE 101 is moved or picked up so that the UE 101 is either above or below the plane of the virtual workspace, the application 113 and/or the virtual workspace manager 111 may render computer imagery that can pan or zoom over the virtual workspace based on the location of the UE 101 with respect to the virtual workspace. More specifically, by raising the UE 101 above the plane of the virtual workspace, the application 113 can render a wider angle view of the virtual workspace so that more of the virtual workspace is visible in the rendered view of the UE 101. In one embodiment, the user interfaces of the respective UEs 101 are partial views to the virtual workspace. Moreover, each of the devices may have different views of the workspace at different zoom levels.

In one embodiment, physical movements of the UEs 101 correspond to equivalent movements in the virtual workspace. These movements (e.g., palming along the virtual workspace) can be used, for instance, to locate virtual objects within the virtual workspace, select the objects, change the properties of the objects, and the like. The location, selection, and changing of the properties can be further specified by different movements (e.g., rotation of the UE 101, alignment of the UE 101, etc.).

Consider, for example, a scenario where a user is operating a cell phone with integrated video capture that is recording the user's current surroundings. The augmented reality (AR) application 113 operable on the cell phone can interact with the video capturing device, location detection systems and any other sensory mechanisms of the cell phone, to overlay various graphic elements atop the recorded image or a virtual representation of the recorded image to show the visible portions of the virtual workspace and the objects contained therein. The graphic elements can convey useful contextual information to the user regarding the images being captured, such as the names of objects, addresses, news data, advertisements, other attractions within proximity to the image being captured, etc., all in real-time. Moreover, the rendered images are contextually relevant to the services and/or applications associated with the virtual workspace. In the current example, the augmented reality application 113 is a client application for generating AR related views respective to detected/shared location, orientation, position, movement or whereabouts information or content (e.g., as determined by a connectivity and position sensor, to be described later). In some instances, the shared services platform 103 can feature various AR related applications as well for interacting with the augmented reality application 113.

In general, the UE 101 may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). Moreover, the UE 101 may execute one or more software applications or utilities, including but not limited to those for enabling or facilitating network access and communication, internet browsing, social networking, e-mail communication, file sharing and data transfer, word processing, data entry, spreadsheet processing, mathematical computation, etc. These applications and utilities may also be interoperable, so as to enable the execution of various features of the aforementioned application and utilities to be simultaneously executed to enable specific user tasks. Data generated by or exchanged with the device, such as by other devices or by way of the shared services platform 103, can be stored to a datastore or memory (not shown) of the UE 101.

Each UE may also have operable thereon one or more connectivity and positioning sensors (CPS) 115a-115n (also collectively referred to as CPS 115) for enabling a respective device to detect the location of other devices relative to the current position of the respective device, orientation of the respective device or movement of the respective device. Furthermore, the CPS 115 enables communication sessions to be established between detected devices to facilitate a means of exclusive communication between the devices for creating the virtual workspace and/or manipulating the services and/or applications depicted in the virtual workspace as described in greater detail below.

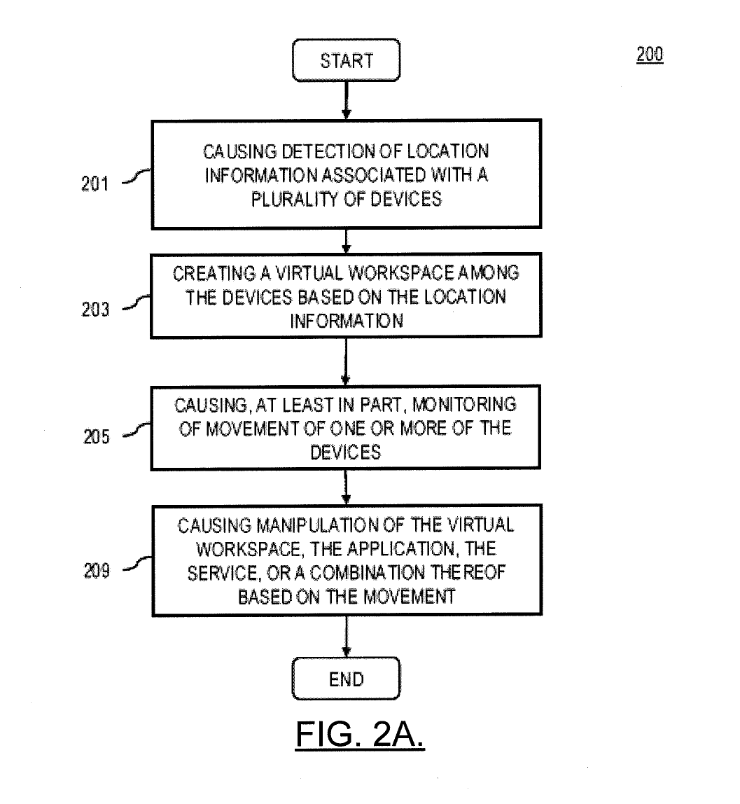

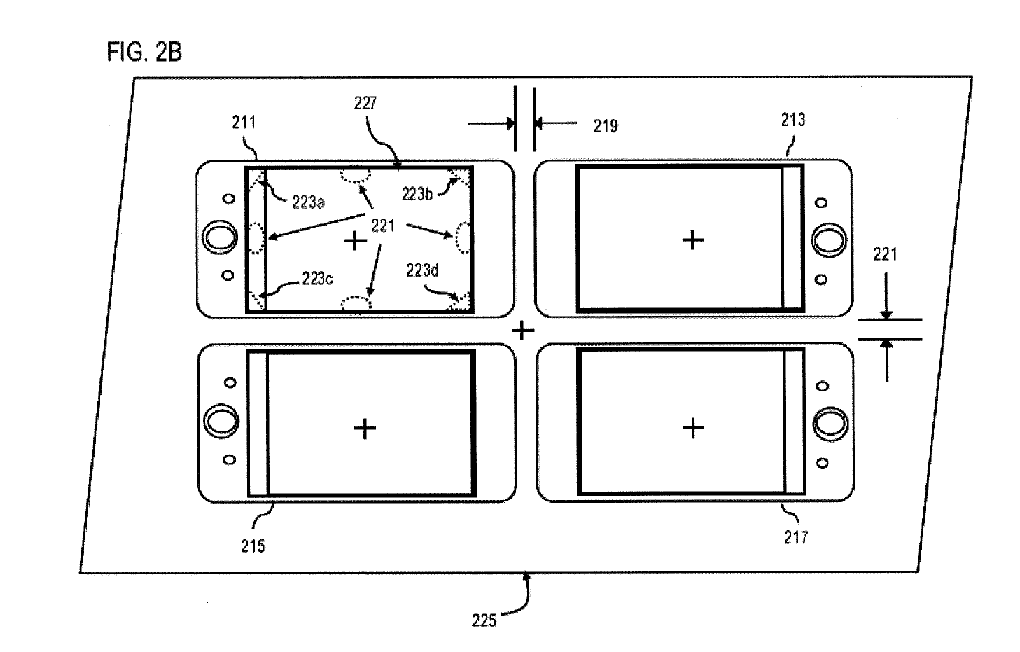

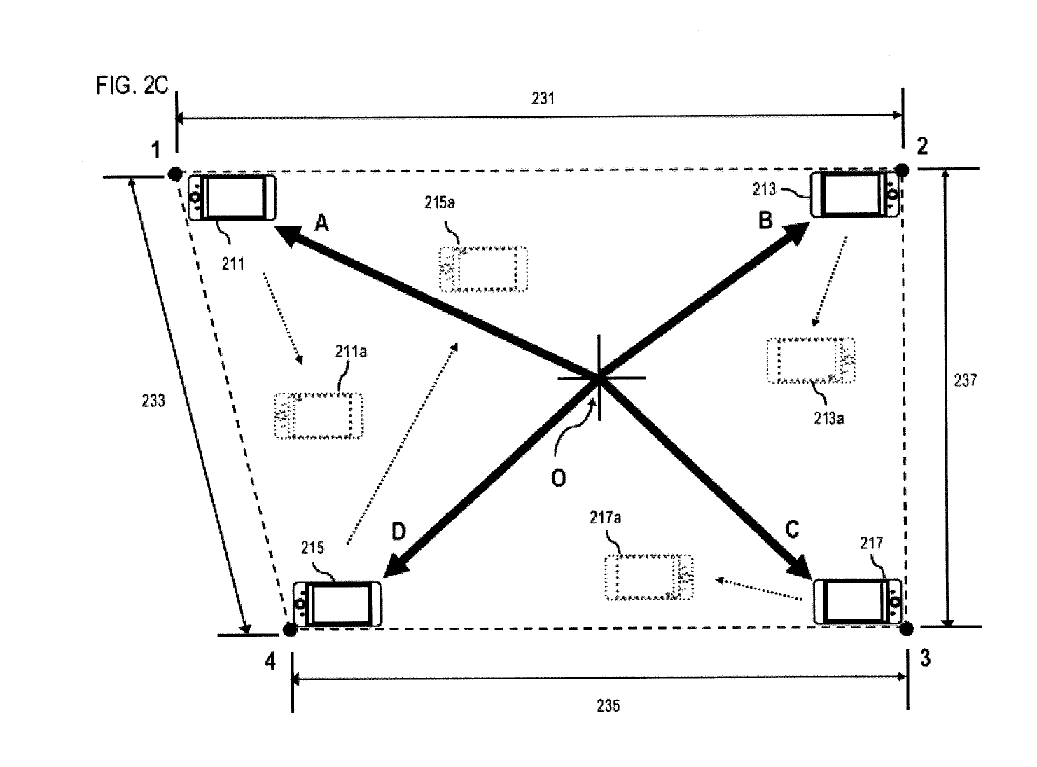

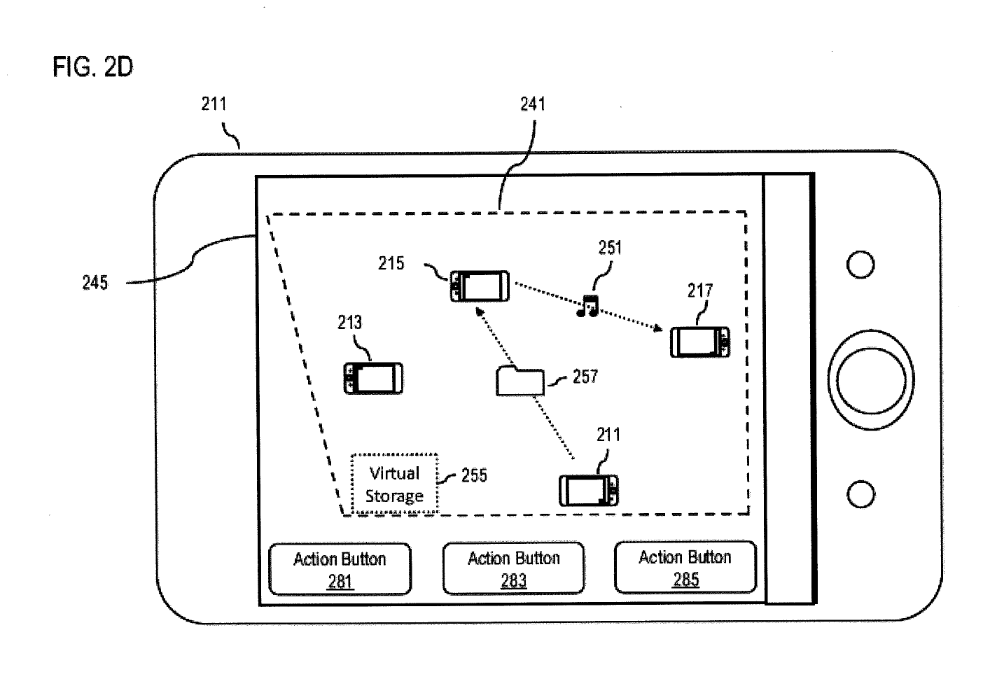

FIG. 2A is a flowchart depicting the process for enabling equipment users to interact with one another within the context of a collaborative, virtual networking environment, according to one embodiment. The process 200 of FIG. 2A is explained with the diagrams of FIGS. 2B-2D depicting UEs 101 interacting to generate and collaborate within a virtual workspace environment of FIG. 2A, according to various embodiments. In one embodiment, the CPS 115 is a positioning system that combines ultrasonic and inertial positioning sensors to detect changes in movement, position, orientation or presence of other devices or UEs 101. In the context of the present invention, this capability facilitates collaborative communication amongst complimentarily placed devices and enables respective devices to perform shared application usage. By way of example, as shown in FIG. 2B, a UE 101's relative position with respect to other nearby UEs 101 is measured using ultrasonic signals while inertial positioning sensors are used to detect shifts in movement from the position. The CPS 115 functionality, while present on each user device 211-217 of FIGS. 2B-2D, will be described from the perspective of a single UE 101, namely user device 211. It will be understood, however, that all of the devices 211-217 shown have the same or substantially the same relative design. Further, while devices 211-217 are depicted as being identical, the CPS 115 functionality as presented herein is applicable to any device type or form factor. Thus, the ability to detect skew or alteration in position, orientation, movement or the like is achievable even with differing sensor types or orientations within a given differing device type.

FIG. 2B depicts a plurality of user devices 211-217 positioned relative to one another to enable shared communication and interaction via virtual workspace. In this example, each device is proximally positioned such that their relative adjacent (side-by-side) distance 221, parallel distance (face-to-face) 219, and/or diagonal distance (not shown) from one another may be determined using the functions of the CPS 115. By way of example, these distances can be calculated, at least in part, based on the extent of distance between complimentary ones of the one or more sensors 221 and 223a-d affixed at various points of two or more user devices 227.

In one example, the devices have four transmitters 221, located at the middle of the device and four receivers 223a-d, located at the corners to constitute at least some of the components of the CPS 115. In certain embodiments, both transmitters and receivers use a small slot opening near the bottom of the device to minimize the risk that the user's hand is blocking the sensors and to create a uniform sensitivity to all directional changes (e.g., filtering out unwanted frequencies from being detected). Moreover, it is contemplated that, in one embodiment, each transmitter 221 as placed has 180 degree radiation patterns while receivers feature 270 degree patterns. This is advantageous in rotational, spatial or kinetic activity algorithm design given that the angle of the transmitter and the receiver can be approximated.

In this example, ultrasonic positioning detection starts with an infrared signal, which is sent by the transmitters 221 uniformly to all directions. This signal serves as a starting point for calculating the ultrasound transmission delay. The IR-signal also has an ID-code which identifies the transmitter and informs the other devices whether the transmitter device is stationary or moving. The IR-signal is also used to define transmission slot for every device to avoid collisions.

The time difference between the beginning of the IR-signal and the instant of reception of the ultrasound burst is used to calculate the distance. The receivers 223a-d analyze the envelope of the burst signal, where the envelope is created using analog electronics rather than fast AD-conversion and processing. From this, the Q-value—the amount of energy released in response to movement of the device—of the transmitters 221 and the receiving circuitry 223a-d is known. Consequently, the burst envelope waveform can be approximated.

The detected waveform is then used in calculating the starting point of the received burst since the beginning of the burst is always below the corresponding noise limit. The transmitted ultrasonic signal is made sufficiently high and bandwidth is minimized in order to minimize external noises from the measurement. Also, signal levels of transmitters 221 are increased using a resonance circuit with a controlled Q-value.

In general, transmitted ultrasonic signals are received with two or more microphones (the receivers 223a-d). Since the dimensions of the user device are known, the distance and the angle of the various transmitters 221 can be calculated using trilateration and clustering techniques. Clustering and trilateration accuracy is improved by combining the positioning data from different devices—in other words, oversampling and then utilizing the average.

Inertial positioning sensors of the CPS functionality 115 are employed using 3D gyroscopes, 3D accelerometers and 3D compass technology. Momentary positions and gestures are persistently calculated as well using the data collected by these devices. Consistent observance of relative positional change is performed for each device individually, as well as relative to each other.

Overall, the CPS functionality 115, implemented in the form of the various sensor arrays described above, can be positioned just below a given phone's display screen and connected to an internal debug serial port. While presented from the perspective of devices aligned along a common plane 225, indeed, the same principles apply when the devices are stacked upon one another. Based on the determined position, movement or orientation of the different devices 211-217 relative to one another, a communication session can be initiated by way of Bluetooth or as a wireless local area network WLAN connection (which may accommodate larger connectivity distance thresholds than Bluetooth). Establishment of this communication session relative to the current locations of devices sets the initial parameters (e.g., boundaries) of the virtual workspace in which the devices will ultimately interact by way of device users. Resultantly, the devices 211-217 can be subsequently moved without eliminating the connection or dissipating the established workspace.

In conjunction with the connectivity and position sensors, each user device (e.g., UE 101 of FIG. 1) can also share spatiotemporal data with a respective shared services platform 103. As used herein, the term “spatiotemporal data” refers to any data that conveys a particular moment in space and time for a particular object in question. Spatiotemporal data is often used in applications where understanding of an object's relative change in location, position or perspective from moment-to-moment is critical. This may include applications such as Geographic Information Systems (GIS), environmental data management systems and multimedia databases.

The overall procedure for enabling interaction of devices within the context of a virtual workspace displayable for corresponding to a representation of physical phenomena is presented with respect to the process 200 of FIG. 2A. Some of the capabilities and applications resulting from the establishment of this virtual workspace are then further explored in FIGS. 2B-2D, as well as the subsequent figures. It will be recognized that establishment of a connection between complimentary devices may include means for accounting for permissions, settings and various other connection requirements.

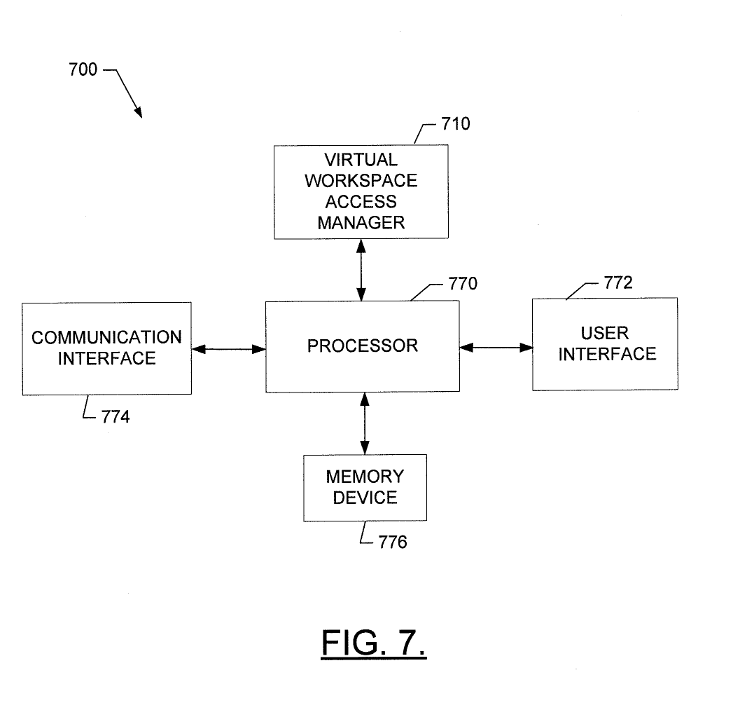

FIG. 2A is a flowchart depicting the process 200 for enabling equipment/device users to interact with one another within the context of a collaborative, virtual networking environment, according to one embodiment. In one embodiment, the virtual workspace manager 111 performs the process 200 and is implemented in, for instance, an apparatus or chip set including a processor and a memory as shown in FIG. 7. In addition or alternatively, all or a portion of the process 200 may be performed by the shared services platform 103 again via a processor and memory as shown in FIG. 7. As an initial operation 201, the devices 211-217 are placed in a manner as presented in FIG. 2B, or within close proximity to one another in some form or fashion, thus causing each device 211-217 to detect location information associated with the plurality of devices 211-217. Alternatively, the connection is performed via a proxy service or interface operable over the communication network 105 (e.g., the Internet) for facilitating the connection between distant or remotely located devices. Having detected the plurality of devices 211-217, a communication session is established between some or all of the devices 211-217, thus initially defining or establishing the virtual workspace that will be rendered ultimately to the individual user device 211-217. This corresponds to operation 203, wherein the initial virtual workspace is bound by the original spatial/physical distances between devices upon establishment of the connection (Example: adjacent distance (side-by-side) 221, parallel distance (face-to-face) 219 of FIG. 2B).

At operation 205, any further movement of the one or more devices 211-217 subsequently is monitored by the interacting devices 211-217. The movement of devices 211-217 subsequent to the establishment of the initial virtual workspace is depicted in FIG. 2C. Specifically, the user of device 211 physically moves a distance from an approximate starting point O in a direction A to a location proximate to point 1. Device 213 moves a distance from the starting point O in a direction B to a location proximate to point 2. Device 217 moves a distance from the starting point O in a direction C to a location proximate to point 3. Finally, device 215 moves a distance in a direction D to a location proximate to point 4. Establishment of the final parameters of the workspace is performed automatically by the virtual workspace manager 111 in conjunction with a specified threshold (e.g., a default or maximum extent of the virtual workspace), or manually by a given device user. Having established the new locations and thus redefined the physical area comprising the workspace, the boundaries defining the virtual work space are also manipulated/adjusted accordingly. For this example, the result is a larger virtual workspace for complimentary devices 211-217 to be shown to interact within. The spatial distances 231, 233, 237 and 235 corresponding to the distance between points 1 and 2, 1 and 4, 2 and 3 and 3 and 4 respectively, characterize the parameters, boundaries or extent of the virtual workspace to be rendered to the display, such as in accordance with a proportional relationship (Example: X sq ft=Y pixels per sq inch resolution).

Given the proportional relationship between the physical distance/location information and the virtual representation thereof, the closer the devices remain to the point of initial connection, the lesser the extent of the virtual workspace available for display. Conversely, the further the devices are moved from the point of initial connection, but within the range of connectivity, the greater the extent of the virtual workspace available for display. The maximum size of the virtual workspace as presented to the user can be fixed (e.g. a predetermined area), defined on the basis of the furthest spatial/physical distance between devices, or can change dynamically based on continuous movements and hence changes in proximity. Hence, the ability to represent the virtual workspace to a device and the location of the virtual objects within it is based on current movement, position, proximity and orientation of devices relative to one another. Further, the scale of the displayed information (e.g. virtual objects) to a display can depend on the proximity of the devices.

In accordance with the exemplary embodiment of FIG. 2D, the virtual workspace 241 as created to correspond to and represent the real-world physical interaction of complimentary devices 211-217 in FIG. 2C may be rendered to the display interface 245 of each device 211-217. In the exemplary embodiment of FIG. 2D, the virtual workspace 241 as generated on user device 211 is shown. In one embodiment, the virtual workspace can be generated by the augmented reality application 113 operating upon each device 211-217, optionally based in part as well on services data 109 provided by the shared services platform 103, where the continuous movement of current devices 211-217 is shown as an overlay atop an area designating the virtual workspace. In one embodiment, the virtual workspace 241 can be generated on an additional user device (not shown in FIG. 2D) provided that it has access rights to information about the virtual workspace, including the devices and content items. It is also contemplated, therefore, that a map, terrain depictions and other visual indicators could be shown to further represent current real-world conditions. Virtual representations of devices 211-217 are therefore shown positioned, located or oriented within the workspace 241 in a manner consistent with current real-time conditions. Still further, an optional virtual storage device 255—a dedicated data store defined for use by the complimentary devices 211-217 is shown.

A benefit afforded by depicting physical events between respective devices in a virtual display 241 is expansion of a user's overall workspace and work capacity. For example, there are various factors that contribute to an enhanced collaborative environment for the user as a result of enhanced operating freedom. These include expanded numbers of devices with which to engage in shared interaction, the ability for the defined boundaries of the workspace to be expanded through repositioning of collaborating devices, an increase in the number of shared applications available for interaction with respective devices, an increase in the number of data sources available for sharing amongst respective devices, etc. All of these factors, whether taken singularly or in combination, result in an experience beyond what the user can expect with a conventional display capability.

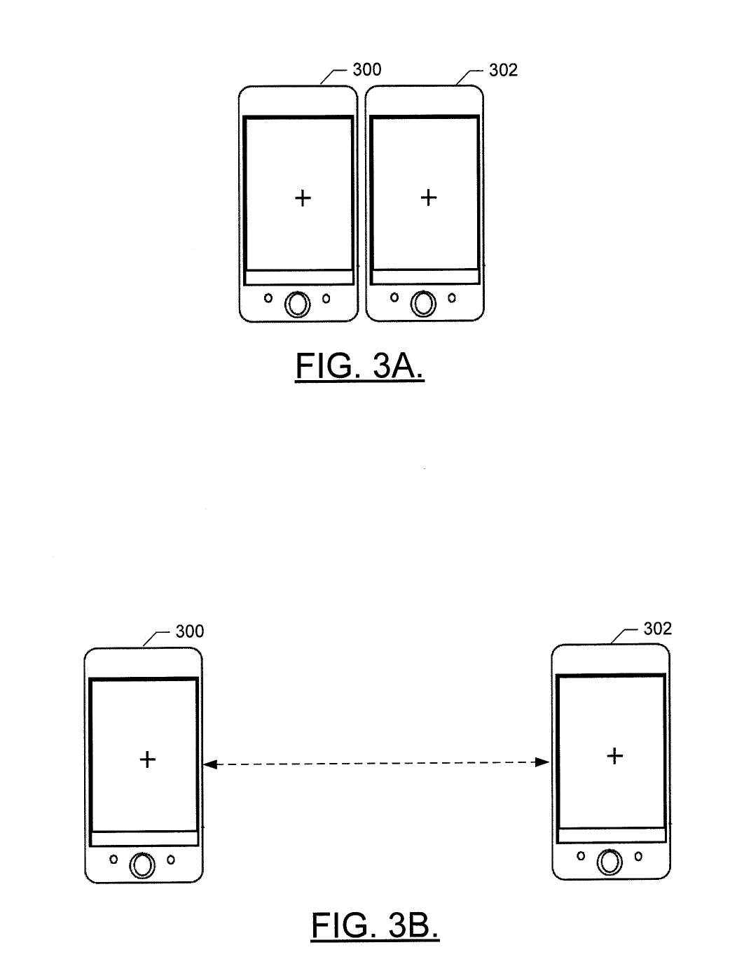

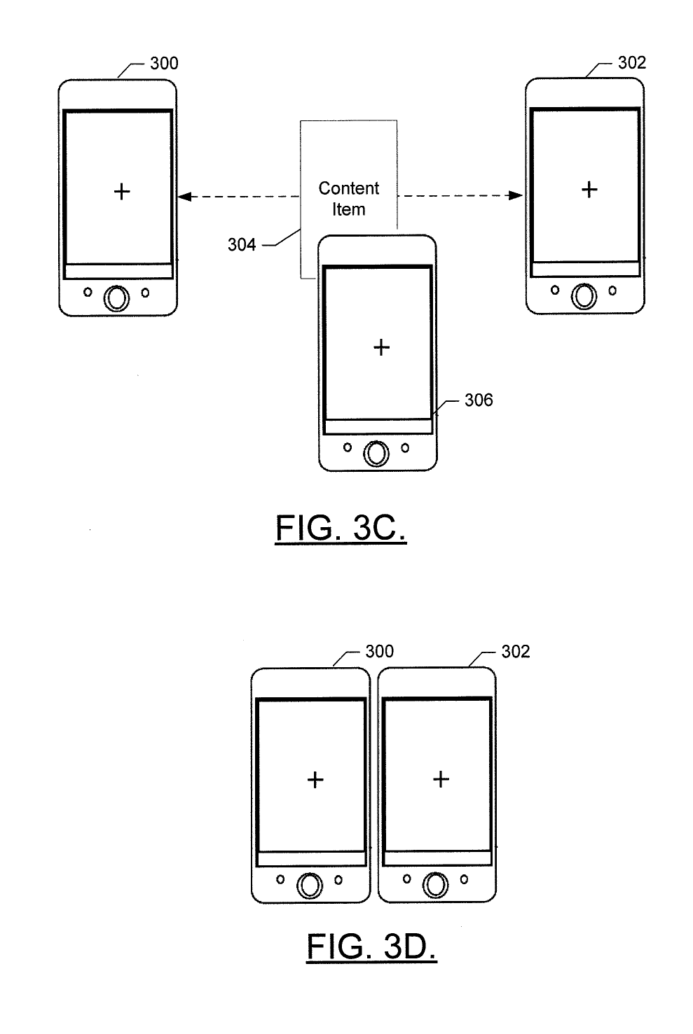

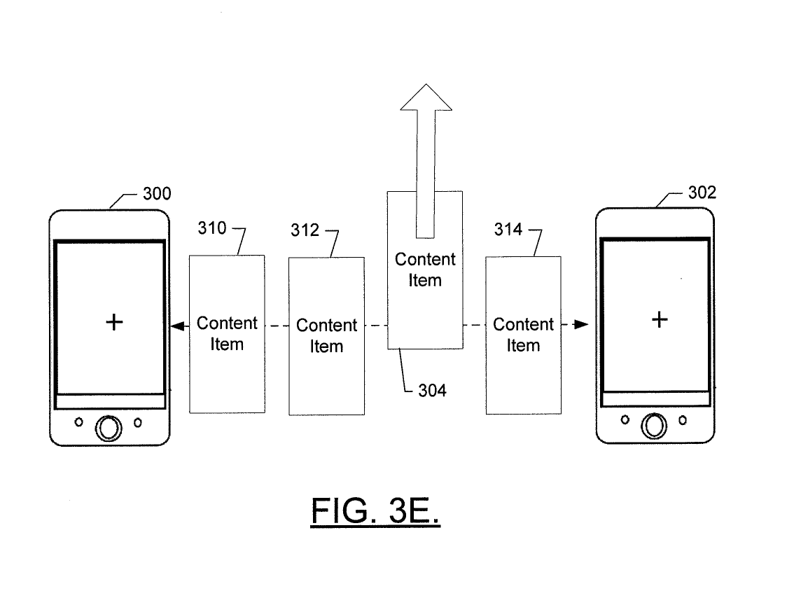

As further movement of user devices occurs within the virtual workspace 241, the user display 245 may be updated to represent the change in location, position or orientation. The display can be updated in accordance with a periodic refresh rate or triggered by any perceived movement. One or more action buttons 281-285 may also be rendered to the display for enabling the execution of various actions and applications to be performed amongst the devices 211-217 within the context of the established workspace 241 connections. In addition or alternatively, the various actions and applications may be executed by a physical movement of one or more of the devices 211-217 (e.g., rotation, stacking, etc.). By way of example, the actions and applications may include file transfer 257, such as presented visually to the display 245 as occurring between devices 211 and 215, music file sharing 251 as occurring between devices 215 and 217, providing for social control (e.g., common and/or coordinated control) of a function or action among one or more of the devices 211-217, or a range of other applications. FIGS. 3A-5G (as described below) present various applications that can be performed by complimentary devices 211-217 within the context of their interaction with a virtual workspace 241. In particular, the range of example capabilities presented herein fall into the general categories of media processing, image processing and data sharing and networking. It will be readily understood through consideration of these categories, however, that numerous other applications not expressly mentioned herein are within the scope of the examples disclosed. The following paragraphs are presented by way of example only.

In an example embodiment, devices may be placed in proximity to each other to create the virtual workspace 241. The creation of the virtual workspace 241 may be triggered by any of a number of events. For example, the occurrence of a predetermined number or specific identities of devices being proximate to each other may create the virtual workspace. In some cases, the devices may be proximate within a specified distance or for a specified duration of time in order to create the virtual workspace 241. Alternatively or additionally, a specific user action may trigger creation of the virtual workspace 241 (e.g., selection of a button, making a swipe action or other such activities). The user action may come from any device in some cases, but may be initiated at a particular device (e.g., a master device used for creating, opening and/or closing of the virtual workspace 241). Combinations of the above and other activities or events may also trigger virtual workspace creation. Moreover, in some cases, if a particular device is designated as a master device, the master device may be enabled to grant access rights to other devices. As an example, some devices may be granted full access to material placed in the virtual workspace 241, while other devices may have more limited access (e.g., read only access) to some or all of the material.

In an example embodiment, the distance between the devices 211-217 may be used as a basis for opening or closing the virtual workspace 241. In this regard, opening the virtual workspace 241 may be understood to mean enabling access to the virtual workspace 241 by authorized devices (e.g., devices 211-217). Meanwhile, closing the virtual workspace 241 may be understood to mean disabling access to the virtual workspace 241. According to an example embodiment, when the virtual workspace 241 is open, content items (e.g., data items of any type such as video, audio, text, executable code, applications, images, etc.) may be placed in the virtual workspace 241. In other words, content may be deposited, uploaded or otherwise made available for access to other devices. This may include one or a plurality of content items.

In some embodiments, when the virtual workspace 241 is open, one or more content items may be placed into the virtual workspace 241 by the devices 211-217 defining the virtual workspace 241 or by third party devices that are authorized to interact with the virtual workspace 241. When the virtual workspace 241 is open, selected ones of the one or more content items may be accessed for processing, rendering, or other use or manipulation by the devices 211-217 defining the virtual workspace 241 or by third party devices that are authorized to interact with the virtual workspace 241. When the virtual workspace 241 is closed, the content items therein may be locked in the virtual workspace 241 so that access to the content items is not available.

As indicated above, the distance between the devices 211-217 defining the virtual workspace 241 may be used to determine whether the virtual workspace 241 is open or closed. As indicated above, the distance and orientation of the devices 211-217 with respect to each other may alter the size and shape of the virtual workspace 241 as it is presented to a user on a display of one of the devices 211-217. However, in some embodiments, a distance parameter may be defined as the distance at which the virtual workspace 241 is to be considered closed. As such, the distance parameter may define a threshold or minimum distance between devices 211-217, which when reached (or when a value lower than the distance parameter is reached) causes the virtual workspace 241 to be closed. The same distance parameter may also be used as a threshold distance that, if exceeded, opens the virtual workspace 241. However, in some embodiments, the distance at which the virtual workspace 241 opens and closes may be selected to be different values. In an example embodiment, the distance parameter that, when sensed, triggers closing of the virtual workspace 241 may be zero or some small or negligible value indicating that the devices 211-217 (or at least a threshold number of the devices) are adjacent to each other or proximate to each other with little to no distance therebetween.

In situations where two devices are used to define the virtual workspace 241, decision making regarding opening and closing of the virtual workspace 241 may be relatively simple as there is only one distance, namely the distance between the two devices, to consider with respect to determining whether the virtual workspace 241 is to be opened or closed. However, when multiple devices are used to define the virtual workspace 241, more complex scenarios may be experienced. Various embodiments of the present invention may provide for corresponding different treatments of the potential scenarios. For example, in some cases, when more than two devices are used to define the virtual workspace 241, the movement of any two of the devices to a distance from each other that is within the value distance parameter may cause the virtual workspace to be closed. However, some embodiments may require that all of the devices, or a selected or threshold number of devices that is more than two, but less than all, move to a distance from each other that is less than or equal to the distance parameter in order to close the virtual workspace 241. In embodiments in which some number of devices move proximate to each other to a distance less than the distance parameter, but not a sufficient number of devices to close the virtual workspace, the shape and size of the virtual workspace 241 may be adjusted according to the positions of the devices that are distant from one another, but the virtual workspace 241 may remain open. Other devices may also be added to the virtual workspace 241 by bringing them within the virtual workspace 241 and the shape and size of the virtual workspace 241 may be enlarged by physically separating such devices or reduced by bringing such devices closer together.

Accordingly, for example, various different characteristics may exist with respect to access status for the virtual workspace 241. As a first example, the virtual workspace 241 may be either open or closed. Additionally or alternatively, a device may be enabled to interact with content items in the virtual workspace 241 to perform such activities as inserting content, removing content, modifying content, etc. Additionally or alternatively, a device may generate a view of the virtual workspace 241. For example, an external device that is not a part of the virtual workspace 241 in the sense that it does not have permission to access content items, may be enabled to generate a view of the virtual workspace 241. In such an example, the distance between two or more devices may define the access status to the virtual workspace 241 and the two or more devices may then grant full access to the external device to the virtual workspace 241.

Accordingly, in some embodiments, the common plane 225 may be a table and all devices may be on the table. A view of the virtual workspace 241 may be shown on one or more of the devices. As such, one or several of the devices may present either a partial view or a full overview of the virtual workspace 241. In some embodiments, at least one of the devices may be picked up from the table. The virtual workspace 241 may remain in the spatial configuration as defined by location of the picked-up device before the picked-up device was picked up. The picked-up device (or devices) may generate an augmented reality view (either full or partial) of the virtual workspace 241. In some embodiments, an additional device (e.g., a device that is not in the common plane 225 to define the virtual workspace 241) may be used to generate an augmented reality view of the virtual workspace 241. The additional device may be provided with the data needed to generate the view by the devices forming the virtual workspace 241.

FIG. 3, which includes FIGS. 3A to 3E, illustrates an example in which a virtual workspace is defined between two devices with access to the virtual workspace being provided based on the distance between the two devices. As shown in FIG. 3A, a first device 300 and a second device 302, each of which may be examples of UEs or other mobile stations, may be placed proximate to each other within a plane (e.g., on a flat surface) to define a closed virtual workspace. FIG. 3B illustrates an opening of the virtual workspace defined between the first device 300 and the second device 302. A content item (e.g., data item 304) may be placed between the two devices in the virtual workspace as shown in FIG. 3C. Thus, for example, a display on either or both of the first and second devices 300 and 302 may render a depiction of the corresponding devices with a linearly extending virtual workspace defined therebetween having the data item 304 disposed therein. In some embodiments, the data item 304 may be placed in the virtual workspace by one of the first or second devices 300 or 302. However, as an alternative, a third device 306 having the data item 304 may be placed in between the first and second devices 300 and 302 to deposit the data item 304 into the virtual workspace. As indicated at FIG. 3D, the virtual workspace may be closed, with the data item 304 therein, by bringing the first and second devices 300 and 302 close to each other to within a distance defined by the distance parameter. The data item 304 may therefore be locked inside the virtual workspace.

As shown in FIG. 3E, a plurality of data items (e.g., including the data item 304 and other items 310, 312 and 314) may be stored along the linearly extending virtual workspace. Generally speaking, the data items may be displayed equally spaced apart and in order like cards from a deck and a user may be enabled to select items from a displayed rendering of the virtual workspace in order to perform operations thereon. Thus, for example, the user may use a finger to grab an item if the display is a touch screen, or a cursor may be moved over the item to select the corresponding item, or any other mechanism for selecting items may be employed. Selected items may then be processed according to the desires, capabilities and/or use restrictions applicable to the user that selects such items. For example, the content item may be rendered, altered, deleted, copied, or communicated to another device or any other type of content processing that is an available option for the device and/or user in question.

In some embodiments, a third party device may be placed into the virtual workspace in order to interact with one of the data items therein. For example, if a data item is being held in the virtual workspace, a third party device that is authorized to interact with the virtual workspace may be moved into the virtual workspace to a location corresponding to a position of one of the data items. The data item may then be transferred to the third party device or may otherwise be made available to the third party device for the third party device to perform operations on the data item.

In an example embodiment, one or more of the devices forming the virtual workspace 241 may have a hard disk connected (storage disk) and the hard disk may be shown on a view of the virtual workspace. Devices may copy files or other data to and/or from the hard disk, e.g. by moving an icon or presentation of an item on top of or near the presentation of the hard disk, moving the device on top of or near the image of the hard disk, or by other methods. In some embodiments, a music file (or other multimedia content) within the virtual workspace 241 may be played by moving the file to a corresponding playback device (e.g., a speaker) that may appear in connection with the view of the virtual workspace 241. For example, the music file may be moved on top of or near a loudspeaker connected to one of the devices. In some embodiments, bringing devices close to each other may make a ZIP file out of objects laid out between the devices in the virtual workspace 241.

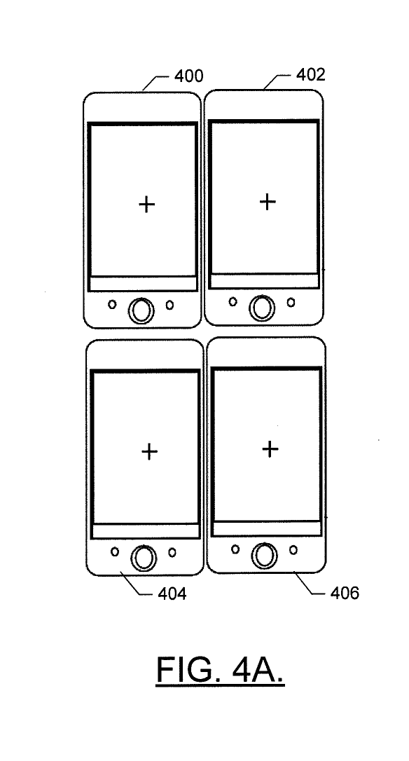

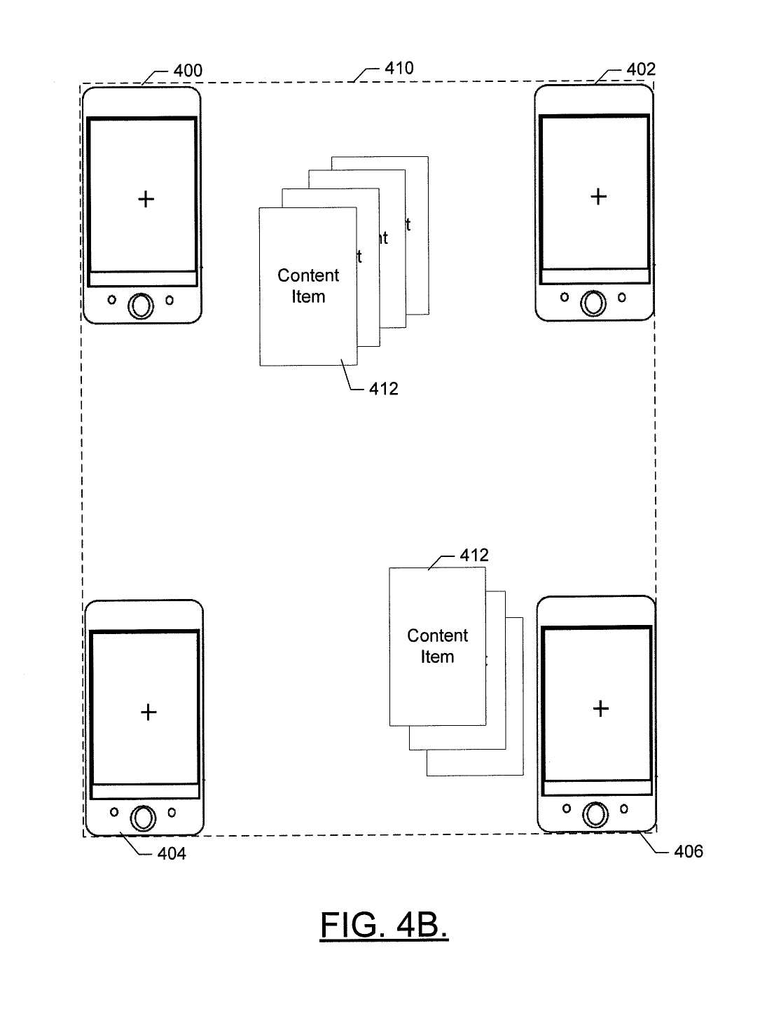

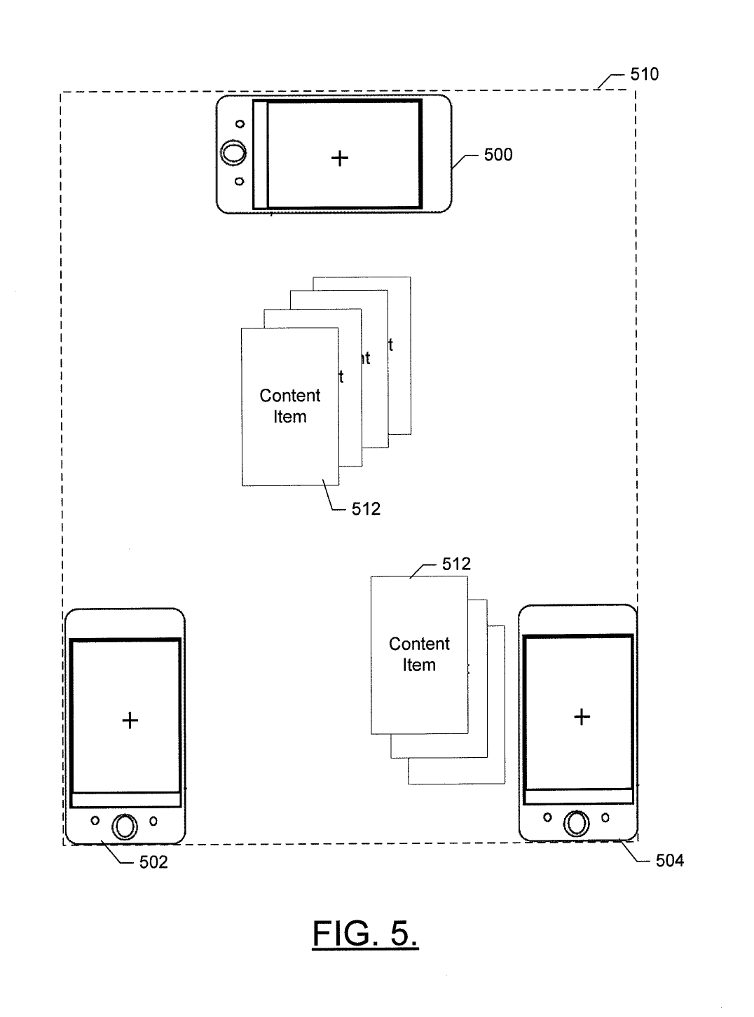

FIG. 4, which includes FIGS. 4A and 4B, illustrates an example embodiment with four devices (e.g., first device 400, second device 402, third device 404 and fourth device 406). FIG. 4A shows the devices in a closed configuration. In this regard, the four devices are proximate to each other and within a distance defined by the distance parameter to thereby close access to the virtual workspace. FIG. 4B shows the devices in an open configuration in which the devices are spaced apart by at least a distance value exceeding the distance parameter in order to open virtual workspace 410. The virtual workspace 410 is also shown with various accessible content items 412 deposited therein. The content items could be evenly spaced apart as previously discussed. However, in some embodiments, rather than spacing the content items 412 apart, the content items 412 may instead be stacked on top of each other. Combinations of stacking and spacing the content items apart may also be employed. FIG. 5 illustrates an embodiment similar to the embodiment of FIG. 4 except that three devices (e.g., first device 500, second device 502 and third device 504) are used to define an open virtual workspace 510 with content item stacks 512 therein. Although the virtual workspace 510 is generally defined as a rectangular space based on the positions of the devices in the example shown in FIG. 5, the virtual workspace 510 could be defined to be any shape based on the positions of the devices either with a default shape (e.g., rectangle, triangle, circle, oval, etc.) having dimensions selected based on device locations or with a shape that is determined merely by extending a line between each consecutive device.

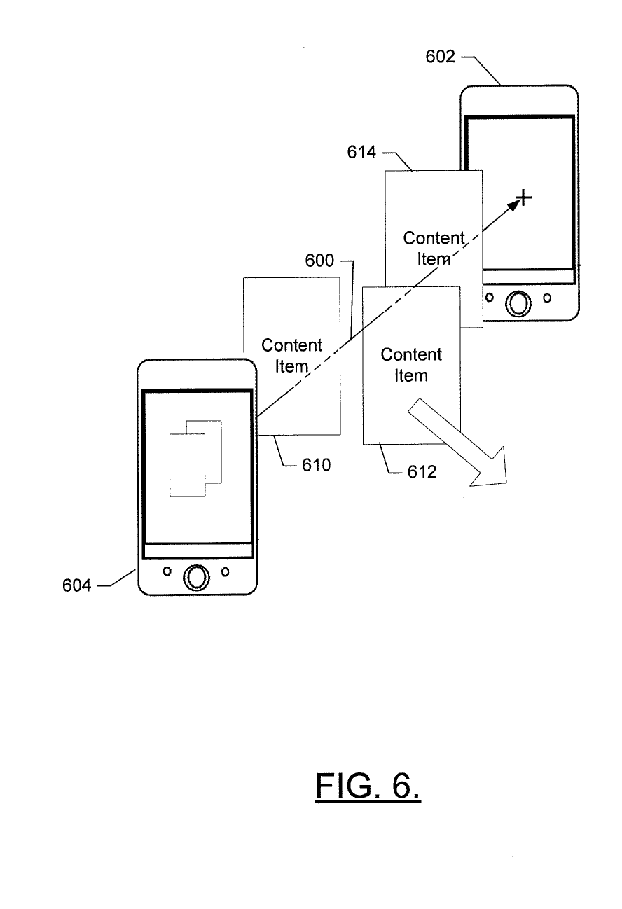

In some embodiments, rather than working with devices positioned in two dimensional (2D) space, thereby rendering the virtual workspace as a corresponding 2D space, the virtual workspace could be considered and rendered as a three dimensional (3D) virtual workspace. FIG. 6 illustrates an example in which a 3D virtual workspace 600 is defined between two devices (e.g., a first device 602 and a second device 604). Content items (e.g., items 610, 612 and 614) may be positioned in the virtual workspace 600 in a spaced apart manner (or in stacks) and may be shown on the screen of one of the devices. One of the content items may be selected (e.g., by selection on a screen of one of the devices, by a finger swipe in the virtual workspace, or by using a third party device as described above) and the selected item may be processed accordingly. In some embodiments, the finger in the space between devices may be captured by a camera on one or both of the devices and its position may be determined (and optionally presented on an augmented reality view of the display including the content items within the virtual workspace 600 and the finger modeled at its relative location). The camera data of the devices may be shared to determine finger location for display in the augmented reality view and for determining whether a particular item is selected and should be indicated as such. The location of a third party device within the virtual workspace 600 may be determined and/or modeled in a similar fashion.

In an example embodiment, determinations regarding opening and closing of a virtual workspace may be made by the virtual workspace manager 111 in cases where operations associated with the performance of example embodiments are performed on the UEs 101. In some embodiments, determinations regarding opening and closing of a virtual workspace may be made by the shared services platform 103. As yet another alternative, responsibility for making such determinations could be split between entities located at the UEs 101 and the shared services platform 103. FIG. 7 illustrates an example embodiment of an apparatus 700 employing a virtual workspace access manager 710 configured to make determinations regarding opening and closing of a virtual workspace (e.g., either at one or more of the UEs 101, at the shared services platform 103, or at a combination of devices) based on distance information regarding the distances between devices defining the virtual workspace.

The apparatus 700 may include or otherwise be in communication with a processor 770, a user interface 772, a communication interface 774 and a memory device 776. In some embodiments, the processor 770 (and/or co-processors or any other processing circuitry assisting or otherwise associated with the processor 770) may be in communication with the memory device 776 via a bus for passing information among components of the apparatus 700. The memory device 776 may include, for example, one or more volatile and/or non-volatile memories. In other words, for example, the memory device 776 may be an electronic storage device (e.g., a computer readable storage medium) comprising gates configured to store data (e.g., bits) that may be retrievable by a machine (e.g., a computing device like the processor 770). The memory device 776 may be configured to store information, data, applications, instructions or the like for enabling the apparatus to carry out various functions in accordance with an example embodiment of the present invention. For example, the memory device 776 could be configured to buffer input data for processing by the processor 770. Additionally or alternatively, the memory device 776 could be configured to store instructions for execution by the processor 770.

The apparatus 700 may, in some embodiments, be a mobile terminal (e.g., one of the UEs 101) or a fixed communication device (e.g., the shared services platform 103) or other computing device configured to employ an example embodiment of the present invention. However, in some embodiments, the apparatus 700 may be embodied as a chip or chip set. In other words, the apparatus 700 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 700 may therefore, in some cases, be configured to implement an embodiment of the present invention on a single chip or as a single “system on a chip.” As such, in some cases, a chip or chipset may constitute means for performing one or more operations for providing the functionalities described herein.

The processor 770 may be embodied in a number of different ways. For example, the processor 770 may be embodied as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 770 may include one or more processing cores configured to perform independently. A multi-core processor may enable multiprocessing within a single physical package. Additionally or alternatively, the processor 770 may include one or more processors configured in tandem via the bus to enable independent execution of instructions, pipelining and/or multithreading.

In an example embodiment, the processor 770 may be configured to execute instructions stored in the memory device 776 or otherwise accessible to the processor 770. Alternatively or additionally, the processor 770 may be configured to execute hard coded functionality. As such, whether configured by hardware or software methods, or by a combination thereof, the processor 770 may represent an entity (e.g., physically embodied in circuitry) capable of performing operations according to an embodiment of the present invention while configured accordingly. Thus, for example, when the processor 770 is embodied as an ASIC, FPGA or the like, the processor 770 may be specifically configured hardware for conducting the operations described herein. Alternatively, as another example, when the processor 770 is embodied as an executor of software instructions, the instructions may specifically configure the processor 770 to perform the algorithms and/or operations described herein when the instructions are executed. However, in some cases, the processor 770 may be a processor of a specific device (e.g., a mobile terminal or network device) adapted for employing an embodiment of the present invention by further configuration of the processor 770 by instructions for performing the algorithms and/or operations described herein. The processor 770 may include, among other things, a clock, an arithmetic logic unit (ALU) and logic gates configured to support operation of the processor 770.

Meanwhile, the communication interface 774 may be any means such as a device or circuitry embodied in either hardware, software, or a combination of hardware and software that is configured to receive and/or transmit data from/to a network and/or any other device or module in communication with the apparatus. In this regard, the communication interface 774 may include, for example, an antenna (or multiple antennas) and supporting hardware and/or software for enabling communications with a wireless communication network. In some environments, the communication interface 774 may alternatively or also support wired communication. As such, for example, the communication interface 774 may include a communication modem and/or other hardware/software for supporting communication via cable, digital subscriber line (DSL), universal serial bus (USB) or other mechanisms.

The user interface 772 may be in communication with the processor 770 to receive an indication of a user input at the user interface 772 and/or to provide an audible, visual, mechanical or other output to the user. As such, the user interface 772 may include, for example, a keyboard, a mouse, a joystick, a display, a touch screen, soft keys, a microphone, a speaker, or other input/output mechanisms. In this regard, for example, the processor 770 may comprise user interface circuitry configured to control at least some functions of one or more elements of the user interface, such as, for example, a speaker, ringer, microphone, display, and/or the like. In an exemplary embodiment in which the apparatus 700 is embodied as a server or some other network device (e.g., the shared services platform 103), the user interface 772 may be remotely located, limited, or eliminated. However, in an embodiment in which the apparatus 700 is embodied as a communication device (e.g., one of the UEs), the user interface 772 may include, among other devices or elements, any or all of a speaker, a microphone, a display, and a keyboard or the like. The processor 770 and/or user interface circuitry comprising the processor 770 may be configured to control one or more functions of one or more elements of the user interface through computer program instructions (e.g., software and/or firmware) stored on a memory accessible to the processor 770 (e.g., memory device 776, and/or the like).

In an example embodiment, the apparatus 700 may include the virtual workspace access manager 710. In this regard, in some embodiments, the virtual workspace access manager 710 may be embodied as the processor 770 or may be a separate entity controlled by the processor 770. As such, in some embodiments, the processor 770 may be said to cause, direct or control the execution or occurrence of the various functions attributed to the virtual workspace access manager 710 as described herein. The virtual workspace access manager 710 may be any means such as a device or circuitry operating in accordance with software or otherwise embodied in hardware or a combination of hardware and software (e.g., processor 770 operating under software control, the processor 770 embodied as an ASIC or FPGA specifically configured to perform the operations described herein, or a combination thereof) thereby configuring the device or circuitry to perform the corresponding functions of the virtual workspace access manager 710 as described herein. Thus, in examples in which software is employed, a device or circuitry (e.g., the processor 770 in one example) executing the software forms the structure associated with such means.

The virtual workspace access manager 710 may be configured to cause the apparatus 700 to receive location information defining a distance between a first device and at least one other device forming a virtual workspace in association with the first device, determine an access status of the virtual workspace based on the location information, and cause enabling or disabling of access to the virtual workspace based on the access status determined. In some embodiments, the virtual workspace access manager 710 may be further configured to enable selection of a content item from the virtual workspace or enable depositing of a content item into the virtual workspace by a device authorized to interact with the virtual workspace in response to access to the virtual workspace being enabled. In an example embodiment, the virtual workspace access manager 710 may be configured to cause the apparatus 700 to cause display of the virtual workspace and at least one content item deposited in the virtual workspace in response to access to the virtual workspace being enabled.

In some example embodiments, when a collaborative, virtual network is established between complimentary devices, one application or service they can perform with respect to content items deposited in (and thereafter selected from) a virtual workspace may include media processing. “Media processing” pertains to the methods by which devices exchange, execute, edit or otherwise manipulate media items such as music, video, audio and other content within the context of an established virtual workspace. Since some example embodiments provide for opening or closing the virtual workspace by enabling or disabling access to content items in the virtual workspace based on the distance between devices defining the virtual workspace, it should be appreciated that access rights management is performed based on the distance between the devices. The access rights management may be practiced with respect to the devices forming the virtual workspace or any other devices that are given access. Moreover, a view of the virtual workspace may be provided by, for example, display of an augmented reality view of the virtual workspace and the contents thereof.

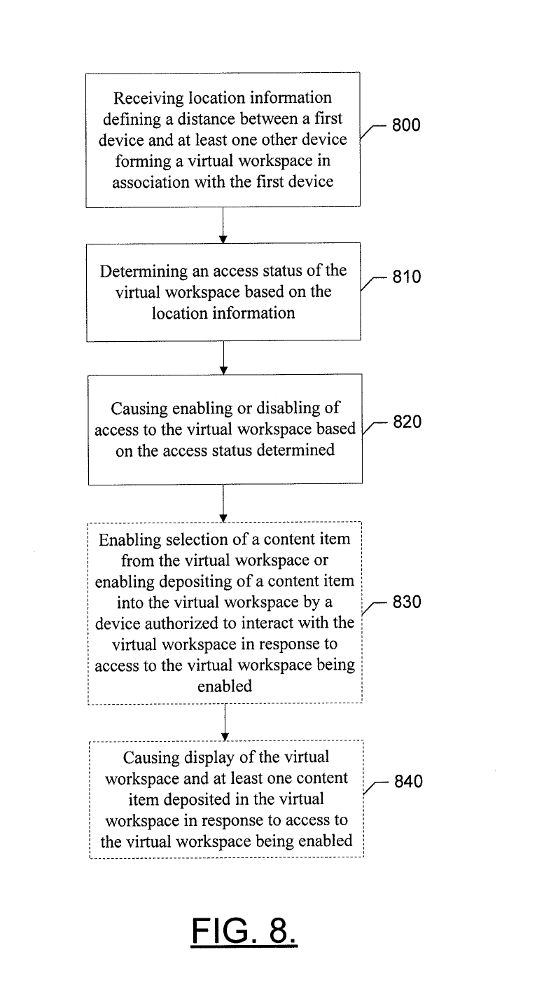

FIG. 8 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal or service platform and executed by a processor in the user terminal or service platform. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 8, may include receiving location information defining a distance between a first device and at least one other device forming a virtual workspace in association with the first device at operation 800, determining an access status of the virtual workspace based on the location information at operation 810, and causing enabling or disabling of access to the virtual workspace based on the access status determined at operation 820.

In some embodiments, certain ones of the operations above may be modified or further amplified as described below. Moreover, in some embodiments additional optional operations may also be included (examples of which is shown in dashed lines in FIG. 8). It should be appreciated that each of the modifications, optional additions or amplifications below may be included with the operations above either alone or in combination with any others among the features described herein in any order. In this regard, for example, the method may further include enabling selection of a content item from the virtual workspace or enabling depositing of a content item into the virtual workspace by a device authorized to interact with the virtual workspace in response to access to the virtual workspace being enabled at operation 830. In an example embodiment, the method may further include causing display of the virtual workspace and at least one content item deposited in the virtual workspace in response to access to the virtual workspace being enabled at operation 840. Either or both of operations 830 and 840 may be added to augment some example embodiments.

In some example embodiments, determining the access status may include comparing the distance to a distance parameter defining a threshold distance below which access to the virtual workspace is to be closed. In an example embodiment, determining the access status may include determining the access status to be open in response to the distance being greater than the distance parameter and determining the access status to be closed in response to the distance being less than or equal to the distance parameter. In some cases, receiving location information may include receiving the location information responsive to movement of at least one of the first device or the at least one other device or at a periodic interval. In an example embodiment, enabling access to the virtual workspace may include enabling an authorized device to insert a content item into the virtual workspace or select a content item in the virtual workspace for processing and disabling access to the virtual workspace may include preventing any device from inserting content items into the virtual workspace or selecting content items for processing. In an example embodiment, causing the display of the virtual workspace may include utilizing image data from the first device and the at least one other device to determine a location of an object in a space between the first device and the at least one other device defining the virtual workspace in order to determine an interaction between the object and the at least one content item. In some embodiments, causing the display of the virtual workspace may include causing a display of a plurality of content items deposited in the virtual workspace such that the content items are displayed spaced apart from each other or stacked on top of each other. In some cases, causing the display of the virtual workspace further may include causing a display of a two dimensional or three dimensional representation of the virtual workspace.

In an example embodiment, an apparatus for performing the method of FIG. 8 above may comprise a processor (e.g., the processor 770) configured to perform some or each of the operations (800-840) described above. The processor may, for example, be configured to perform the operations (800-840) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 800-840 may comprise, for example, the virtual workspace access manager 710. Additionally or alternatively, at least by virtue of the fact that the processor 770 may be configured to control or even be embodied as the virtual workspace access manager 710, the processor 770 and/or a device or circuitry for executing instructions or executing an algorithm for processing information as described above may also form example means for performing operations 800-840.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation

What is claimed is:

1. A method comprising:
receiving location information defining a distance between a first device and at least one other device forming a virtual workspace in association with the first device;
determining an access status of the virtual workspace based on the location information; and
causing enabling or disabling of access to the virtual workspace based on the access status determined.

2. The method of claim 1, wherein determining the access status comprises comparing the distance to a distance parameter defining a threshold distance below which access to the virtual workspace is to be closed.

3. The method of claim 2, wherein determining the access status comprises determining the access status to be open in response to the distance being greater than the distance parameter and determining the access status to be closed in response to the distance being less than or equal to the distance parameter.

4. The method of claim 1, wherein receiving location information comprises receiving the location information responsive to movement of at least one of the first device or the at least one other device or at a periodic interval.

5. The method of claim 1, wherein enabling access to the virtual workspace comprises enabling an authorized device to insert a content item into the virtual workspace or select a content item in the virtual workspace for processing and wherein disabling access to the virtual workspace comprises preventing any device from inserting content items into the virtual workspace or selecting content items for processing.

6. The method of claim 1, further comprising causing a display of the virtual workspace and at least one content item deposited in the virtual workspace in response to access to the virtual workspace being enabled.

7. The method of claim 6, wherein causing the display of the virtual workspace further comprises utilizing image data from the first device and the at least one other device to determine a location of an object in a space between the first device and the at least one other device defining the virtual workspace in order to determine an interaction between the object and the at least one content item.

8. The method of claim 6, wherein causing the display of the virtual workspace further comprises causing a display of a plurality of content items deposited in the virtual workspace such that the content items are displayed spaced apart from each other or stacked on top of each other.

9. The method of claim 6, wherein causing the display of the virtual workspace further comprises causing a display of a two dimensional or three dimensional representation of the virtual workspace.

10. The method of claim 1, further comprising enabling selection of a content item from the virtual workspace or depositing of a content item into the virtual workspace by a device authorized to interact with the virtual workspace in response to access to the virtual workspace being enabled.

11. An apparatus comprising at least one processor and at least one memory including computer program code, the at least one memory and the computer program code configured to, with the at least one processor, cause the apparatus at least to:
receive location information defining a distance between a first device and at least one other device forming a virtual workspace in association with the first device;
determine an access status of the virtual workspace based on the location information; and
cause enabling or disabling of access to the virtual workspace based on the access status determined.

12. The apparatus of claim 11, wherein the at least one memory and the computer program code are configured to, with the at least one processor, cause the apparatus to determine the access status based on comparing the distance to a distance parameter defining a threshold distance below which access to the virtual workspace is to be closed.

13. The apparatus of claim 12, wherein the at least one memory and the computer program code are configured to, with the at least one processor, cause the apparatus to determine the access status by determining the access status to be open in response to the distance being greater than the distance parameter and determining the access status to be closed in response to the distance being less than or equal to the distance parameter.

14. The apparatus of claim 11, wherein the at least one memory and the computer program code are configured to, with the at least one processor, cause the apparatus to receive location information including receiving the location information responsive to movement of at least one of the first device or the at least one other device or at a periodic interval.

15. The apparatus of claim 11, wherein the at least one memory and the computer program code are configured to, with the at least one processor, cause the apparatus to enable access to the virtual workspace by enabling an authorized device to insert a content item into the virtual workspace or select a content item in the virtual workspace for processing and disable access to the virtual workspace by preventing any device from inserting content items into the virtual workspace or selecting content items for processing.

16. The apparatus of claim 11, wherein the at least one memory and the computer program code are further configured to, with the at least one processor, cause the apparatus to cause display of the virtual workspace and at least one content item deposited in the virtual workspace in response to access to the virtual workspace being enabled.

17. The apparatus of claim 16, wherein the at least one memory and the computer program code are configured to, with the at least one processor, cause the apparatus to cause the display of the virtual workspace including utilizing image data from the first device and the at least one other device to determine a location of an object in a space between the first device and the at least one other device defining the virtual workspace in order to determine an interaction between the object and the at least one content item.

18. The apparatus of claim 16, wherein the at least one memory and the computer program code are configured to, with the at least one processor, cause the apparatus to cause the display of the virtual workspace including:
causing a display of a plurality of content items deposited in the virtual workspace such that the content items are displayed spaced apart from each other or stacked on top of each other; or
causing a display of a two dimensional or three dimensional representation of the virtual workspace.

19. The apparatus of claim 11, wherein the at least one memory and the computer program code are configured to, with the at least one processor, cause the apparatus to enable selecting a content item from the virtual workspace or depositing of the content item into the virtual workspace by a device authorized to interact with the virtual workspace in response to access to the virtual workspace being enabled.

20. A computer program product comprising at least one computer-readable storage medium having computer-executable program code instructions stored therein, the computer-executable program code instructions including program code instructions to:
receive location information defining a distance between a first device and at least one other device forming a virtual workspace in association with the first device;
determine an access status of the virtual workspace based on the location information; and
cause enabling or disabling of access to the virtual workspace based on the access status determined.
